(19) United States
(12) Patent Application Publication
(10) Pub. No.: US 2011/0122191 A1
(43) Pub. Date: May 26, 2011

(54) LIQUID EJECTING APPARATUS AND CONTROL METHOD THEREOF

(75) Inventor: Shinichi TSUBOTA, Azumino-shi (JP)

(73) Assignee: SEIKO EPSON CORPORATION, Tokyo (JP)

(21) Appl. No.: 12/914,119

(22) Filed: Oct. 28, 2010

(30) Foreign Application Priority Data
Nov. 25, 2009 (JP) 2009-267184

(51) Int. Cl. B41J 2/165

(52) U.S. Cl. 347/26

(57) ABSTRACT

A printer controller generates a foam elimination flushing driving signal that includes a foam elimination flushing process driving pulse for eliminating foam within the ink flow channel by driving a piezoelectric element; a foam elimination flushing process for restoring the ejection capability of a recording head is carried out using the foam elimination flushing driving signal before ink within the ink flow channel is heated by a heating mechanism.

The entire disclosure of Japanese Patent Application No: 2009-267184, filed Nov. 25, 2009 are expressly incorporated by reference herein.

### BACKGROUND

1. Technical Field

The present invention relates to liquid ejecting apparatuses such as ink jet printers and to control methods thereof, and particularly relates to a liquid ejecting apparatus that performs a maintenance process for restoring the ejection capability of a liquid ejecting head and to a control method thereof.

2. Related Art

A liquid ejecting apparatus is an apparatus that, for example, is provided with a liquid ejecting head capable of ejecting a liquid from a nozzle, and that ejects various types of liquid from this liquid ejecting head. An image recording apparatus such as an ink jet printer (called simply a “printer” hereinafter) that is provided with an ink jet recording head (called simply a “recording head” hereinafter) as its liquid ejecting head and that records images, text, and so on by causing ink in liquid form to be ejected from a nozzle in the recording head and land upon a recording medium such as recording paper (a landing target) can be given as a representative example of such a liquid ejecting apparatus.

Here, the stated ink jet printer (called simply a “printer” hereinafter) is provided with a recording head that includes, for example, a serial ink flow channel extending from a reservoir to a nozzle and passing through a pressure chamber, a pressure generation unit for causing fluctuations in the volume of the pressure chamber (for example, a piezoelectric element), and so on, and also includes a driving signal generation unit and so on that generates a driving signal for driving the pressure generation unit. In this configuration, fluctuations in the pressure of ink within the pressure chamber are instigated by applying driving pulses included in the driving signal to the piezoelectric element, and the ink is ejected from the nozzle by using these pressure fluctuations. With such a printer that employs an ink jet technique, there are cases where foam intrudes into the ink flow channel, such as into the pressure chamber or the like, and the foam absorbs the fluctuations in the pressure; this leads to ejection problems such as ink not being ejected (so-called “missing dots”), skew in the flight direction of the ejected ink, and so on.

Accordingly, various techniques related to maintenance processes have been proposed in order to prevent such ejection problems and maintain favorable ink ejection. For example, a cleaning process is carried out in which the nozzle is temporarily sealed with a cap and the interior of the cap is depressurized during the sealed state; ejection driving pulses are then applied to the piezoelectric element, thus instigating fluctuations in the pressure of the ink within the pressure chamber and performing non-printing ink ejections, which forcefully ejects hardened ink, foam, and so on. However, even if the stated cleaning process is executed, it has been difficult to completely eliminate foam. Note that “non-printing ejection” refers to ejecting ink for the purpose of restoring the ejection properties of the recording head to a normal state (that is, a state that is close to the ejection properties intended by design/specification); this is separate from ejecting ink for printing images or the like onto a recording medium, which is the original purpose of the printer.

In addition to the aforementioned cleaning process, a flushing process is carried out in this type of printer as a maintenance process for forcefully ejecting ink from the nozzle. To be more specific, the recording head is moved to an ink receiving member that is in a location away from the recording medium and non-printing ejection of the ink is repeatedly carried out at this location; this is carried out after the aforementioned cleaning process, after an initial fill when the ink cartridge has been replaced, or once every predetermined unit of printing during a printing process (that is, during recording operations), such as, for example, each time printing has been carried out for a set period of time, every predetermined number of passes (recording head scans) has been carried out, or every time a predetermined number of pages has been printed. In addition to a hardened ink discharge flushing process for performing non-printing ejection of ink with the primary aim of discharging ink that has hardened in the vicinity of the nozzle, flushing processes also include a foam elimination flushing process that aims primarily at removing foam from in the ink (for example, JP-A-2009-073074).

Meanwhile, in recent years, there are situations where the aforementioned liquid ejecting apparatuses are used to eject liquids having a viscosity of approximately 30 to 40 mPas at normal temperatures (for example, 15 to 25° C.) (called “high-viscosity liquids” hereinafter). Such high-viscosity inks are advantageous in that they are unlikely to bleed upon the recording paper and thus are unlikely to result in unevenness in the darkness of the recorded image; furthermore, such inks dry quickly. Ultraviolet light-curable inks, liquid crystals, and so on that are cured by irradiating the liquid with ultraviolet light are also examples of high-viscosity liquids. When such high-viscosity liquids are ejected from a nozzle in a recording head, the ejection properties, such as the amount (mass·volume) of ink that is ejected and the flight speed, are affected by the viscosity of the ink; thus techniques in which the ink is ejected after first reducing the viscosity of the ink by heating the ink with a heating unit have been proposed in order to ensure stable ejection properties (for example, see JP-A-2003-182103 and JP-A-2006-334967).

However, in such a configuration in which a high-viscosity liquids such as ink is heated, if the aforementioned foam elimination flushing process is carried out in a state in which the liquid is at a high temperature (for example, 40° C. or more), the solubility of the foam with respect to the liquid is lower than when the liquid is at normal temperature, and thus there is a risk that the process will conversely create foam within the ink.

### SUMMARY

An advantage of some aspects of the invention is to provide a liquid ejecting apparatus capable of improving the discharge properties of foam during a maintenance process and to provide a control method for such a liquid ejecting apparatus.

An aspect of the invention is a liquid ejecting apparatus including: a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber; a heating unit that directly or indirectly heats the liquid; and a control unit that controls ejection operations of the liquid ejecting head and controls the heating unit. The control unit is configured to be capable of generating a maintenance driving signal that includes a maintenance pulse that removes foam from within the liquid flow channel by driving the pressure generation unit; and the control unit carries out a maintenance process for restoring the ejection capability of the liquid ejecting head using the maintenance driving signal before the liquid within the liquid flow channel is heated by the heating unit.

Note that “to eliminate foam” refers to a phenomenon in which foam is discharged from the nozzle along with liquid that is ejected from the nozzle, including a phenomenon in which foam within the liquid flow channel is caused to dissolve into the liquid.

According to this aspect of the invention, the maintenance process for restoring the ejection capability of the liquid ejecting head is carried out before the liquid within the liquid flow channel is heated by the heating unit, and thus the foam can be prompted to dissolve into the liquid with more certainty, making it possible to eliminate the foam with more certainty. Accordingly, in the following ejection operations such as printing processes, the liquid can be ejected in a stable manner in a state in which the amount of foam remaining in the liquid has been reduced, thus making it possible to prevent ejection problems caused by the foam. Furthermore, compared to the case where the maintenance process is carried out in a state in which the liquid is at a high temperature, the total number of maintenance pulses applied to the pressure generation unit that are required in order to eliminate the foam within the liquid can be reduced, making it possible to reduce the amount of time required for the maintenance process.

Another aspect of the invention is a liquid ejecting apparatus including: a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber; a heating unit that directly or indirectly heats the liquid; and a control unit that controls ejection operations of the liquid ejecting head and controls the heating unit. The control unit is configured to be capable of generating a maintenance driving signal that includes a maintenance pulse that removes foam from within the liquid flow channel by driving the pressure generation unit; and the control unit controls the heating unit so that the temperature of the liquid within the liquid flow channel when a maintenance process for restoring the ejection capability of the liquid ejecting head using the maintenance driving signal is carried out is lower than the temperature of the liquid within the liquid flow channel when the liquid is ejected onto a landing target.

According to this aspect of the invention, the heating unit is controlled so that the temperature of the liquid within the liquid flow channel when a maintenance process is carried out is lower than the temperature of the liquid within the liquid flow channel when the liquid is ejected onto a landing target, and thus the foam can be prompted by the maintenance process to dissolve into the liquid with more certainty, making it possible to eliminate the foam with more certainty. Accordingly, in the following ejection operations such as printing processes, the liquid can be ejected in a stable manner in a state in which the amount of foam remaining in the liquid has been reduced, thus making it possible to prevent ejection problems caused by the foam. Furthermore, compared to the case where the maintenance process is carried out in a state in which the liquid is at a high temperature, the total number of maintenance pulses applied to the pressure generation unit that are required in order to eliminate the foam within the liquid can be reduced, making it possible to reduce the amount of time required for the maintenance process.

In the aforementioned configurations, it is desirable for the liquid ejecting apparatus to further include a liquid holding member that holds the liquid and a supply unit that supplies the liquid within the liquid holding member to the liquid ejecting head, and for the heating unit to include a supply-side heating unit that directly or indirectly heats the liquid supplied from the liquid holding member to the liquid ejecting head and a head-side heating unit that directly or indirectly heats the liquid within the liquid flow channel of the liquid ejecting head, and the control unit to put the supply-side heating unit in a heating state and put the head-side heating unit in a non-heating state when performing the maintenance process.

According to this configuration, the temperature of the liquid drops by the time the liquid reaches the pressure chamber, the nozzle, and so on of the liquid ejecting head even while the ease of supply of the liquid from the liquid holding member to the liquid ejecting head is ensured; thus the foam is in a more soluble state with respect to the liquid during the maintenance process than when the liquid is heated by at least the head-side heating unit, which makes it possible to sufficiently discharge the foam within the liquid.

Furthermore, in the aforementioned configurations, it is desirable for, by driving the pressure generation unit, the maintenance pulse to include: a first change section in which a potential changes in a first direction and causes the volume of the pressure chamber to change; a holding section in which the ending potential of the first change section is held for a set amount of time and the volume of the pressure chamber changed by the first change section is held; and a second change section in which the potential changes from the ending potential of the first change section in a second direction, which is the opposite direction of the first direction, and causes the volume of the pressure chamber to change; and for the maintenance pulse to be set so that the pressure change within the pressure chamber is greater than the pressure change resulting from an ejection driving pulse for ejecting the liquid onto a landing target.

Another aspect of the invention is a control method for a liquid ejecting apparatus, the liquid ejecting apparatus including a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber, a heating unit that directly or indirectly heats the liquid, and a control unit that controls ejection operations of the liquid ejecting head and controls the heating unit, the method including: generating a maintenance driving signal that includes a maintenance pulse that removes foam from within the liquid flow channel by driving the pressure generation unit; and carrying out a maintenance process for restoring the ejection capability of the liquid ejecting head using the maintenance driving signal before a process for heating the liquid within the liquid flow channel is executed by the heating unit.

Another aspect of the invention is a control method for a liquid ejecting apparatus, the liquid ejecting apparatus including a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber, a heating unit that directly or indirectly heats the liquid, and a control unit that controls ejection operations of the liquid ejecting head and controls the heating unit, the method including: generating a maintenance driving signal that includes a maintenance pulse that removes foam from within the liquid flow channel by driving the pressure generation unit; and controlling the heating unit so that the temperature of the liquid within the liquid flow channel when a maintenance process for restoring the ejection capability of the liquid ejecting head using the maintenance driving signal is carried out is lower than the temperature of the liquid within the liquid flow channel when the liquid is ejected onto a landing target.

### BRIEF DESCRIPTION OF THE DRAWINGS

The invention will be described with reference to the accompanying drawings, wherein like numbers reference like elements.

FIG. 1 is a plan view illustrating the configuration of a printer.

FIG. 2 is an exploded perspective view of a recording head.

FIG. 3 is a cross-sectional view illustrating the principal constituent elements of a head unit.

FIG. 4 is a block diagram illustrating the electrical configuration of a printer.

FIG. 5 is a waveform diagram illustrating the structure of a foam elimination flushing driving signal.

FIG. 6 is a flowchart illustrating operations of a printer.

FIG. 7 is a cross-sectional view illustrating the configuration of a recording head and the vicinity of a platen according to a variation.

FIG. 8 is a schematic diagram illustrating the configurations of a recording head, an ink cartridge, and an ink supply system according to a variation.

### DESCRIPTION OF EXEMPLARY EMBODIMENTS

Hereinafter, an embodiment of the invention will be described with reference to the appended drawings. Although various limitations are made in the embodiment described hereinafter in order to illustrate a specific preferred example of the invention, it should be noted that the scope of the invention is not intended to be limited to this embodiment unless such limitations are explicitly mentioned hereinafter. An ink jet recording apparatus (referred to as a “printer”) will be given hereinafter as an example of a liquid ejecting apparatus according to the invention.

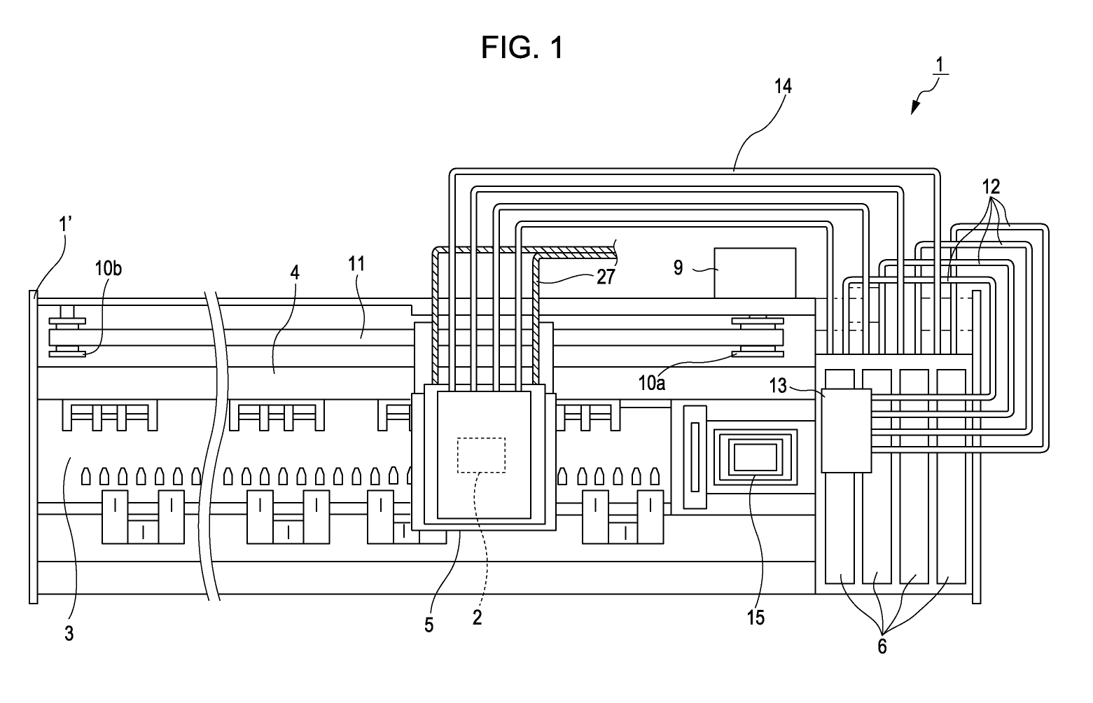

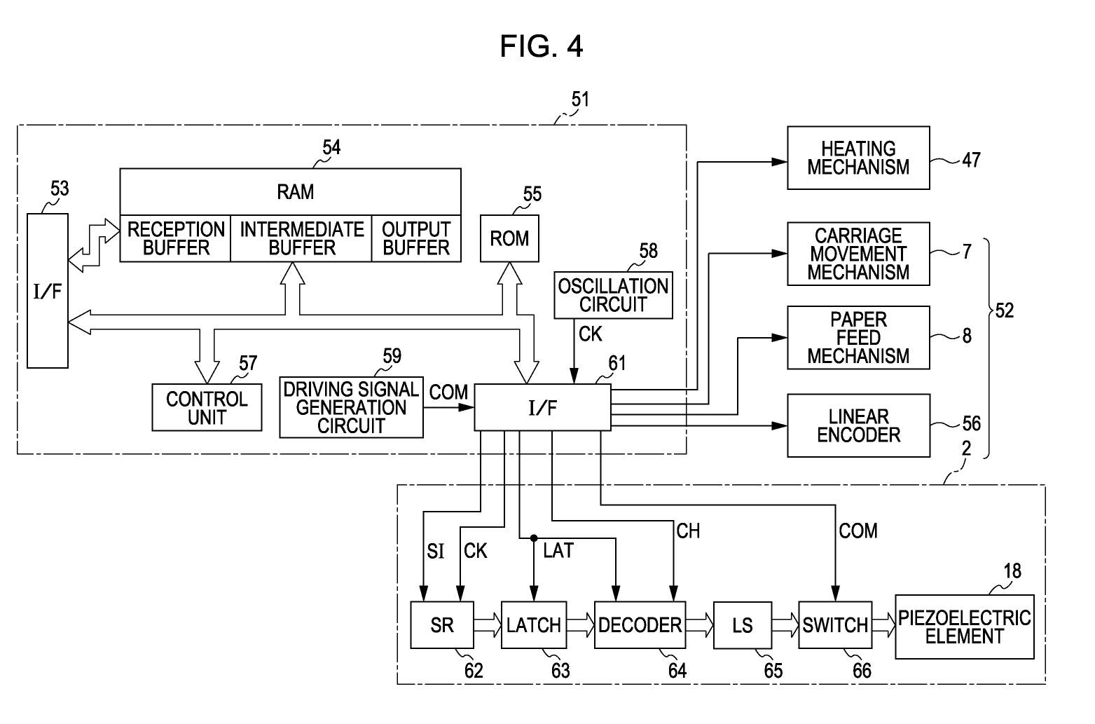

FIG. 1 is a plan view illustrating the configuration of a printer 1 according to the invention. The printer 1 includes a frame 1′ that partially configures an outer hull and a platen 3 disposed within the frame 1′; recording paper (not shown; a type of recording medium or landing target) is transported along the surface of the platen 3 by a paper feed roller that is rotated by the driving of a paper feed motor (neither of which are shown here) within a paper feed mechanism 8 (see FIG. 4). In addition, a guide rod 4 is mounted within the frame 1′ parallel to the platen 3, and a carriage 5, which houses an ink jet-type recording head 2 (a type of liquid ejecting head; referred to as a “recording head” hereinafter), is supported by the guide rod 4 so as to be capable of sliding. The carriage 5 is connected to a timing belt 11 that is stretched between a driving pulley 10a that rotates as a result of the driving performed by a carriage movement motor 9 and a slave pulley 10b provided on the opposite side of the frame 1′ as the driving pulley 10a. The configuration is such that the carriage 5 moves back and forth along the guide rod 4 in a main scanning direction, which is perpendicular to a paper feed direction, as a result of the driving performed by the carriage movement motor 9. In other words, a carriage moving mechanism 7 (see FIG. 4) is configured of the carriage movement motor 9, the driving pulley 10a, the slave pulley 10b, and the timing belt 11.

The carriage movement motor 9 functions as a driving source for the carriage moving mechanism 7, and uses, for example, a pulse motor, a DC motor, or the like. The rotational speed, rotational direction, and so on of the carriage movement motor 9 are controlled by a control unit 57 (see FIG. 4) that functions as a control unit. When the carriage movement motor 9 rotates, the driving pulley 10a and the timing belt 11 rotate as a result, and the carriage 5 moves along the guide rod 4. In other words, the recording head 2 provided within the carriage 5 moves back and forth in the main scanning direction under the control of the control unit 57. Note that the scanning position of the carriage 5 can be detected by a linear encoder 56 (see FIG. 4) that outputs encoder pulses based on the scanning position as main scanning direction location information.

Ink cartridges 6 (a type of liquid holding member) is installed in a removable state on one side of the frame 1′, and a total of four ink cartridges 6 are provided in this embodiment. Each of the ink cartridges 6 is connected to an air pump 13 (a type of supply unit) via an air tube 12, and the air pump 13 supplies the air to each of the ink cartridges 6. The configuration is such that ink is supplied (pressure-transferred) to the recording head 2 through ink supply tubes 14 due to pressurization of the air within the ink cartridges 6. The ink supply tubes 14 are flexible hollow members created from a synthetic resin such as silicone, and an ink flow channel is formed within each of the ink supply tubes 14 in correspondence with each of the ink cartridges 6.

A home position is set in the region between the platen 3 and the ink cartridges 6 that is within the movement range of the carriage 5. The recording head 2 is positioned at the home position when in a standby state. A capping mechanism 15 capable of sealing a nozzle formation surface (a nozzle plate 38) of the recording head 2 while in a non-recording state is disposed at the home position. This capping mechanism 15 also functions as a flushing point for receiving ink and the like discharged from nozzles 37 during a foam elimination flushing process, which is a maintenance process and will be described later.

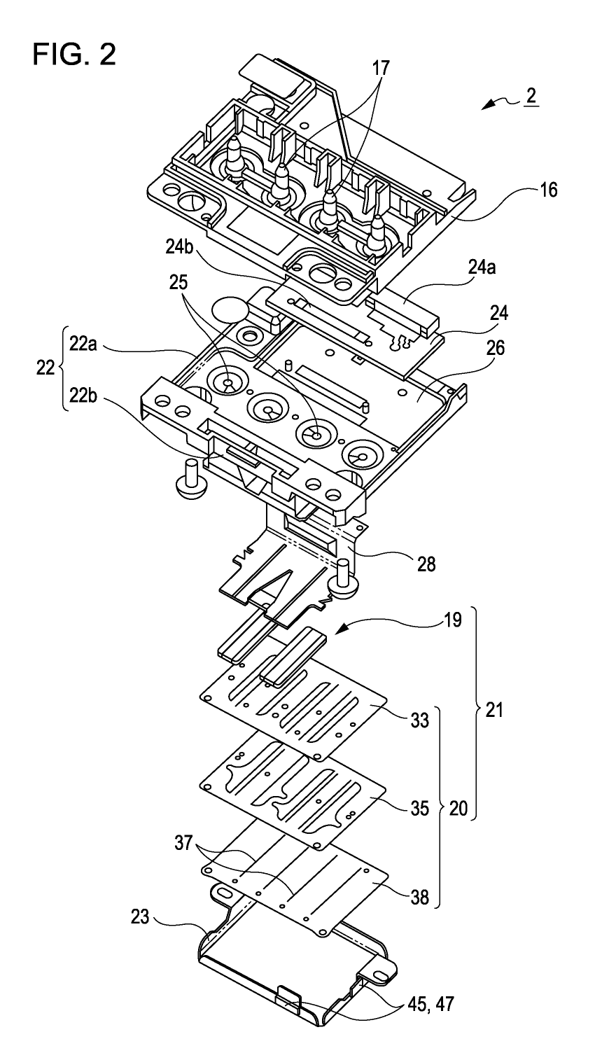

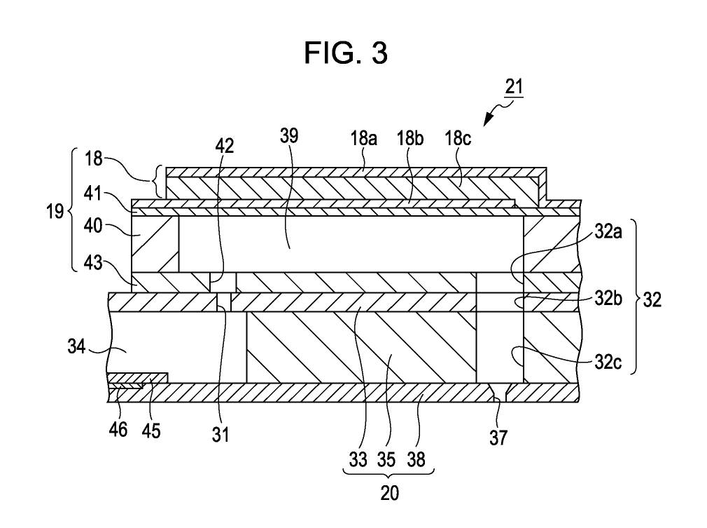

FIG. 2 is an exploded perspective view illustrating an example of the configuration of the recording head 2. The recording head 2 is generally configured of a head case 22 in which are provided an introduction needle unit 16 in which are disposed multiple ink introduction needles 17 that introduce ink (a type of liquid according to the invention; also a type of high-viscosity liquid) held in the aforementioned ink cartridges 6 into the interior of the head and a head unit 21 configured of a pressure generation unit 19 having a piezoelectric element 18 (see FIG. 3) and a flow channel unit 20. Furthermore, in this recording head 2, a metal head cover 23, for protecting the head unit 21 and grounding the nozzle plate 38, is attached to the leading side of the head case 22 (that is, the side that is on the opposite side of the bonding surface with the introduction needle unit 16).

The introduction needle unit 16 is a member, created from a synthetic resin, in which the ink introduction needles 17 are disposed side-by-side in the main scanning direction of the head (that is, the direction perpendicular to nozzle rows). The ink introduction needles 17 disposed in the introduction needle unit 16 are hollow cylindrical members whose tip portions are sharpened to points. Introduction holes (not shown) that pass into interior channels of the ink introduction needles 17 are provided in the tip portions of the ink introduction needles 17, and ink supplied from the ink cartridges 6 through the ink supply tubes 14 is introduced into the ink flow channels (liquid flow channels) of the recording head 2 through these introduction holes.

The head case 22 is a member that is configured of a base portion 22a to which the aforementioned introduction needle unit 16, a driving board 24, and so on are attached, and a hollow box-shaped case portion 22b, which extends downward from the bottom portion of the base portion 22a and to which the head unit 21 is attached at an opening surface of the case portion 22b. Upper openings of ink supply channels 25 that supply ink introduced from the introduction needle unit 16 to reservoirs (mentioned later) are provided in the base portion 22a of the head case 22, in locations corresponding to the ink introduction needles 17 of the introduction needle unit 16. In addition, a board mounting portion 26 onto which the driving board 24 is disposed is provided in the base portion 22a.

The stated driving board 24 includes a connector 24a, and a wiring cable 27 (see FIG. 1) such as an FFC (flexible flat cable) from the printer itself is connected to the connector 24a. In addition, a connection terminal 24b is formed in the driving board 24, and a film-form flexible cable 28 such as a TCP (tape carrier package) is electrically connected to the connection terminal 24b. The driving board 24 receives driving signals from the printer itself through the wiring cable 27, and the driving signals are then supplied to the piezoelectric element 18 of the pressure generation unit 19 via the flexible cable 28.

FIG. 3 is a cross-sectional view illustrating the principal constituent elements of the aforementioned head unit 21. The head unit 21 according to this embodiment is configured with the pressure generation unit 19 stacked upon the top surface of the flow channel unit 20 (an actuator mounting surface) in an integrated manner therewith. The flow channel unit 20 is configured of a supply opening plate 33 in which are formed an ink supply opening 31 functioning as an orifice and a through-hole 32b serving as part of a nozzle communication opening 32, a reservoir plate 35 in which are formed a reservoir 34 (a common liquid chamber) into which ink is supplied from the ink introduction needles 17 and a through-hole 32c serving as part of the nozzle communication opening 32, and a nozzle plate 38 in which the nozzles 37 are provided. Multiple nozzles 37 are provided in the nozzle plate 38 in rows at a pitch corresponding to the dot formation density, and in this embodiment, four such nozzle rows (a nozzle row being a type of nozzle group) are provided side-by-side in the main scanning direction. The flow channel unit 20 is configured by disposing the nozzle plate 38 on one of the surfaces of the reservoir plate 35 and the supply opening plate 33 on the other surface of the reservoir plate 35 and bonding these members together. The flow channel unit 20 forms an ink flow channel (liquid flow channel) extending from the reservoir 34 to the nozzles 37.

The pressure generation unit 19 includes, in a stacked state, a pressure chamber plate 40 in which a through-hole serving as a pressure chamber 39 is provided, a vibrator plate 41 on which multiple piezoelectric elements 18 are mounted side-by-side and which partially encloses the pressure chamber 39, and a communication opening plate 43 in which are formed a through-hole serving as a supply-side communication opening 42 and a through-hole 32a serving as part of the nozzle communication opening 32. The pressure chamber plate 40, the vibrator plate 41, and the communication opening plate 43 are created of a ceramic such as alumina, zirconia, or the like, and are integrated as a single entity through firing.

The aforementioned pressure chamber 39 is a long, thin, hollow cavity extending in the direction perpendicular to the nozzle rows, and multiple pressure chambers 39 are formed in correspondence with the nozzles 37. One side of each pressure chamber 39 communicates with the reservoir 34 through the supply-side communication opening 42 and the ink supply opening 31. Meanwhile, the other side of the pressure chamber 39 on the side opposite to the supply-side communication opening 42 communicates with the nozzles 37 through the nozzle communication opening 32. Part of this pressure chamber 39, or in other words, the surface on the opposite side as the communication opening plate 43, is enclosed by the vibrator plate 41.

Multiple piezoelectric elements 18 are provided on the outside surface of the vibrator plate 41, which is on the side opposite to the side that faces the pressure chamber 39, in correspondence with respective pressure chambers 39. The piezoelectric element 18 illustrated as an example here (a type of pressure generation unit) is a vibrator having a so-called flexurally-vibrating mode, and is configured of a piezoelectric member 18c being sandwiched between a driving electrode 18a and a common electrode 18b. When a driving signal (driving pulse) is applied to the driving electrode of the piezoelectric element 18, an electric field based on a potential difference between the driving electrode 18a and the common electrode 18b is generated. The piezoelectric member 18c deforms in accordance with the strength of the generated electric field. In other words, as the potential of the driving electrode 18a increases, the piezoelectric member 18c constricts in the direction perpendicular to the electric field, thus causing the vibrator plate 41 to deform so that the volume of the pressure chamber 39 decreases.

A heating element 45, configured of a sheathed heater, is disposed in the reservoir 34 of the head unit 21 in this embodiment. Furthermore, a temperature detection unit such as a thermistor (not shown) is provided within the reservoir 34, and a heating mechanism 47 (see FIG. 4) is configured from the heating element 45 and the temperature detection unit. The heating mechanism 47 (a type of heating unit according to the invention) is connected to a printer controller 51; the configuration is such that when the heating element 45 is electrified through a lead line 46, the heating element 45 emits heat, thus heating the ink within the reservoir 34. The temperature of the ink within the reservoir 34 is detected by the temperature detection unit, and is then ascertained by the printer controller 51. The heating mechanism 47 causes the viscosity of a high-viscosity ink, such as a light-curable ink that has a viscosity of 30 to 40 mPa·s at normal temperature (for example, around 20° C.), to drop to a viscosity of 5 to 15 mPa·s by heating the ink to a predetermined temperature (for example, 40° C.). In this manner, with the recording head 2, the ink is ejected from the nozzles 37 after first reducing the viscosity of the ink to a value that is suited for ejection using the heating mechanism 47, and thus it is possible to achieve stable ejection properties (ink mass, flight speed, and so on). Note that the printer 1 according to the invention can also handle other high-viscosity water-based and solvent-based inks, in addition to light-curable inks.

FIG. 4 is a block diagram illustrating the electrical configuration of the printer 1. This printer 1 is broadly configured of the printer controller 51 and a print engine 52. The printer controller 51 corresponds to a control unit according to the invention; the printer controller 51 generates a driving signal including a driving pulse for driving the piezoelectric elements 18 of the recording head 2, and drives the piezoelectric elements 18 to deform through potential changes in the driving pulse. The printer controller 51 includes an external interface (external I/F) 53 through which print data and the like is inputted from an external apparatus such as a host computer; a RAM 54 that stores various types of data; a ROM 55 that stores control routines and the like for various types of data processes; the control unit 57 that controls the various units; an oscillation circuit 58 that emits a clock signal; a driving signal generation circuit 59 that generates driving signals that are supplied to the recording head 2; and an internal interface (internal I/F) 61 for outputting pixel data obtained by expanding print data on a dot-by-dot basis, driving signals, and so on to the recording head 2.

The control unit 57 outputs a head control signal for controlling operations of the recording head 2 to the recording head 2, outputs a control signal for generating the driving signal to the driving signal generation circuit 59, and so on. The control unit 57 also functions as a timing pulse generation unit that generates a timing pulse PTS from an encoder pulse EP outputted from the linear encoder 56 based on the scanning position of the recording head 2. The timing pulse PTS is a signal that defines the timing at which the driving signal generated by the driving signal generation circuit 59 is generated. The driving signal generation circuit 59 outputs a driving signal each time the timing pulse PTS is received. To rephrase, the driving signal is repeatedly generated every unit cycle split by the timing pulse PTS. Meanwhile, the control unit 57 outputs a latch signal LAT, a change (channel) signal CH, and so on to the recording head 2 in synchronization with the timing pulse PTS. The latch signal LAT is a signal that defines the timing at which a unit cycle T of the driving signal starts, whereas the change signal CH defines the timing of the start of the supply of the driving pulse included in the driving signal.

The driving signal generation circuit 59 (the driving signal generation unit) generates a recording driving signal including a recording ejection driving pulse used for the original purpose of the printer, which is to record images or the like by ejecting ink onto a recording medium (landing target) such as recording paper. In addition to the recording driving signal, the driving signal generation circuit 59 according to this embodiment is configured so as to be capable of generating multiple maintenance driving signals (foam discharge flushing driving signals) that include maintenance pulses (flushing driving pulses). Details of a maintenance process that uses such a maintenance driving signal will be given later.

The configuration of the print engine 52 will be described next. The print engine 52 is configured of the recording head 2, the carriage movement mechanism 7, the paper feed mechanism 8, and the linear encoder 56. The recording head 2 includes multiple shift registers (SR) 62, latches 63, decoders 64, level shifters (LS) 65, switches 66, and piezoelectric elements 18, corresponding to each of the nozzles 37. Pixel data (SI) from the printer controller 51 undergoes serial transmission to the shift register 62 in synchronization with the clock signal (CK) from the oscillation circuit 58.

The latch 63 is electrically connected to the shift register 62, and when a latch signal (LAT) is inputted into the latch 63 from the printer controller 51, the pixel data in the shift register 62 is latched. The pixel data latched in the latch 63 is inputted into the decoder 64. The decoder 64 translates the 2-bit pixel data and generates pulse selection data. The pulse selection data according to this embodiment is configured of data of a total of 2 bits.

The decoder 64 then outputs the pulse selection data to the level shifter 65 upon receiving the latch signal (LAT) or the channel signal (CH). In this case, the pulse selection data is inputted into the level shifter 65 starting with the most significant bit. The level shifter 65 functions as a voltage amplifier, and outputs, if the pulse selection data is “1”, an electric signal having a voltage capable of driving the switch 66, or in other words, a voltage that has been boosted, for example, by approximately several tens of volts. The pulse selection data “1” boosted by the level shifter 65 is supplied to the switch 66. A driving signal COM from the driving signal generation circuit 59 is supplied to the input of the switch 66, and the piezoelectric element 18 is connected to the output of the switch 66.

The pulse selection data controls the operation of the switch 66, or in other words, controls the supply of a driving pulse within the driving signal to the piezoelectric element 18. For example, during the period where the pulse selection data inputted into the switch 66 is “1”, the switch 66 enters a connected state, and the corresponding driving pulse is supplied to the piezoelectric element 18; the potential level of the piezoelectric element 18 changes in accordance with the waveform of the driving pulse. Meanwhile, during the period where the pulse selection data is “0”, no electric signal causing the switch 66 to operate is outputted from the level shifter 65. Accordingly, the switch 66 enters a disconnected state, and a driving pulse is not supplied to the piezoelectric element 18.

Next, a maintenance process for restoring the ejection capability of the recording head 2 carried out in the context of the aforementioned configuration will be described.

With this type of the printer, there are cases where air (foam) intrudes into the ink when the ink within an ink cartridge that has been newly mounted initially fills the ink flow channels of the recording head. As time passes following the filling of the ink, the air gradually dissolves throughout the ink, ultimately resulting in a saturated state. Ink in which air has dissolved to a saturated state in this manner will be referred to as “saturated ink” for simplicity. With such saturated ink, the solubility drops as the temperature rises, and the air that has been dissolved in the ink appears as foam and collects within the ink flow channel when ink is sequentially ejected from the nozzles during the printing process and pressure fluctuations are repeated, and the temperature of the ink rises due to the heating of the heating mechanism, and so on. Foam that has accumulated within the ink flow channel absorbs pressure changes occurring during the ejection of ink, and there is thus a risk that the aforementioned ejection problems will occur.

Accordingly, with the printer 1 according to the invention, a foam elimination flushing process is carried out as a maintenance process for restoring the recording head 2 to a normal state, or in other words, to a state in which the ejection problems are prevented and ink is properly ejected from the nozzles 37 (that is, a state that is close to the ejection properties intended by design/specification). In this foam elimination flushing process, a flushing driving pulse (described later) is applied to the piezoelectric elements 18, thus causing the non-printing ejection of ink from the nozzles 37 and discharging the foam along with the ink; this is carried out separately from the printing process (ejection operations) for ejecting ink in order to print images or the like onto a recording medium. This foam elimination flushing process is executed before the heating process is carried out by the heating mechanism 47, such as when the printer 1 is turned on, after the ink from a newly-mounted ink cartridge has been filled into the recording head 2, and so on.

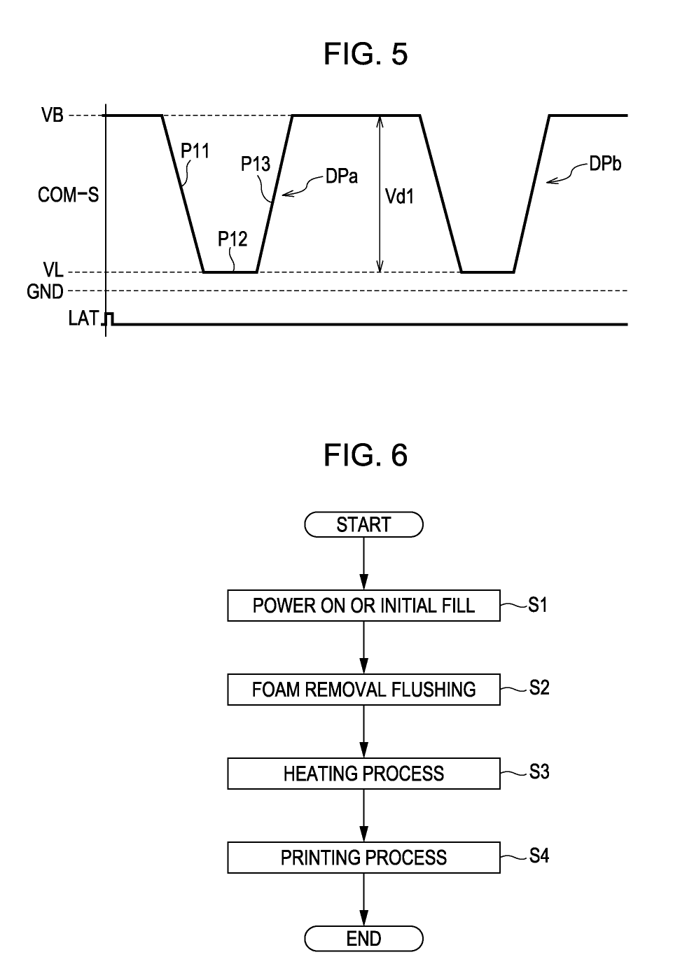

FIG. 5 is a diagram illustrating a foam elimination flushing driving signal COM-S (a type of maintenance driving signal according to the invention) used in the foam elimination flushing process. This driving signal COM-S is configured so as to include two foam elimination flushing driving pulses DP (DPa and DPb) within a unit cycle split by a timing signal (LAT). Note that the number of foam elimination flushing driving pulses DP included in the unit cycle is not limited to the two discussed as examples in this embodiment.

A base potential (a potential that serves as the basis of potential changes in the driving pulse) VB of this driving signal is adjusted to a potential corresponding to a state in which the pressure chamber 39 is contracted due to the piezoelectric element 18 displacing by the maximum possible range toward the pressure chamber 39 (a contraction potential). Note that an expansion potential VL is a potential corresponding to a state in which the pressure chamber 39 is expanded due to the piezoelectric element 18 displacing by the maximum possible range in the direction away from the pressure chamber 39 (an expansion potential).

The foam elimination flushing driving pulse DP (a type of maintenance pulse according to the invention) is a driving pulse that is set so that the pressure fluctuation arising within the pressure chamber 39 when the piezoelectric element 18 is driven becomes sufficiently larger than the aforementioned recording ejection driving pulse, and as a result can impart a more certain pressure change with respect to the foam within the ink flow channel, which in turn increases the ability to discharge the foam. The foam elimination flushing driving pulse DP is configured of an expansion element P11 (a first change section) in which the potential changes in the negative direction (a first direction) from the base potential VB (the contraction potential) to the expansion potential VL, thus causing the pressure chamber 39 to expand; an expansion holding element P12 (a holding section) that holds the expansion potential VL for a set amount of time; and a contraction element P13 (a second change section) in which the potential changes in the positive direction (a second direction) from the expansion potential VL to the base potential VB, thus causing the pressure chamber 39 to contract suddenly. In other words, the foam elimination flushing driving pulse DP is configured of a series of waveform elements for causing pressure changes within the pressure chamber 39 in order to cause the foam within the ink flow channel to dissolve into the ink.

When the foam elimination flushing driving pulse DP is applied to the piezoelectric element 18, first, the piezoelectric element 18 bends in the direction away from the pressure chamber 39 due to the expansion element P11, and as a result, the pressure chamber 39 expands from a contracted volume that corresponds to the base potential VB to an expanded volume that corresponds to the expansion potential VL. As a result of this expansion, the meniscus at the nozzle 37 retracts significantly toward the pressure chamber 39. This expanded state of the pressure chamber 39 is held during the interval in which the expansion holding element P12 is supplied. After this, the piezoelectric element 18 bends toward the pressure chamber 39 due to the application of the contraction element P13. The pressure chamber 39 suddenly contracts from the expanded volume to the contracted volume due to the displacement of the piezoelectric element 18. The ink within the pressure chamber 39 is pressurized as a result of the sudden contraction of the pressure chamber 39, and the ink is ejected from the nozzle 37 as a result. The amount and flight speed of the ink ejected from the nozzle 37 during this foam elimination flushing process are both greater than those occurring during the printing process, other flushing processes, and so on.

FIG. 6 is a flowchart illustrating operations performed by the printer 1 according to this embodiment. First, in step S1, the printer 1 is turned on (power ON). Alternatively, in the case where a new ink cartridge 6 has been mounted in the printer 1, the interior of the recording head 2 is filled with the ink from the ink cartridge 6 (an initial fill). Thus the ink that fills the interior of the ink flow channels of the recording head 2 is at a comparatively low temperature (for example, 15 to 25° C.) after the printer 1 has been turned on, after the initial fill, or the like and before heating has been carried out by the heating mechanism 47. In this state, the printer controller 51 that functions as the control unit executes the maintenance process, or in other words, the foam elimination flushing process (step S2).

In the foam elimination flushing process, the printer controller 51 controls the carriage moving mechanism 7, causing the recording head 2 to move to a flushing point (not shown) that is set above the capping mechanism 15 or in a region at an end of the platen 3. In this state, the printer controller 51 repeatedly applies the foam elimination flushing driving pulse DP generated by the driving signal generation circuit 59 to the piezoelectric element 18, thus continuously executing a predetermined number of non-printing ejections of ink for each of the nozzles 37. These continuous non-printing ejections are called continuous flushing segments. Note that the applying frequency of the foam elimination flushing driving pulse DP to the piezoelectric element 18 (that is, the driving frequency) is set to, for example, approximately 2 kHz. In this foam elimination flushing process, pressure changes that are significantly larger than the pressure changes occurring during ejections in the printing process act on the foam that has accumulated within the ink flow channel. The foam within the ink flow channel is prompted to dissolve into the ink through the repetition of such strong pressure changes. Accordingly, the foam that has accumulated within the ink flow channel can be discharged from the nozzles 37 along with ink.

Once the foam elimination flushing process has been executed for a predetermined number of flushing segments, the printer controller 51 then controls the heating mechanism 47, thus carrying out a heating process on the ink (step S3). While monitoring the temperature detected by the temperature detection unit, the printer controller 51 causes the viscosity of the ink to decrease to a viscosity that is suitable for ejection by heating the ink within the reservoir 34 to a predetermined temperature (for example, 40° C.). In this embodiment, the ink within the reservoir 34, which is close to the nozzles 37 from which the ink is ejected, is heated, and therefore the viscosity of the ink can be adjusted in a more precise manner. Once the ink has been heated and the viscosity thereof has been reduced, the printing process, which records images or the like onto a recording medium such as recording paper, is executed using the recording driving pulse (step S4).

In this manner, with the printer 1 according to the invention, the foam elimination flushing process is carried out before the ink is heated by the heating mechanism 47, and thus the foam can be prompted to dissolve into the ink with more certainty. Accordingly, in the following printing processes, the ink can be ejected in a stable manner in a state in which the amount of foam remaining in the ink has been reduced, thus making it possible to prevent ejection problems caused by the foam. Furthermore, the number of flushing segments required to eliminate the foam within the ink (that is, the total number of foam elimination flushing driving pulses DP applied to the piezoelectric element 18) can be reduced as compared to the case where a flushing process is carried out when the ink is at a high temperature, and thus the time required for the foam elimination flushing process can be reduced. Accordingly, it is possible to smoothly move to the printing process.

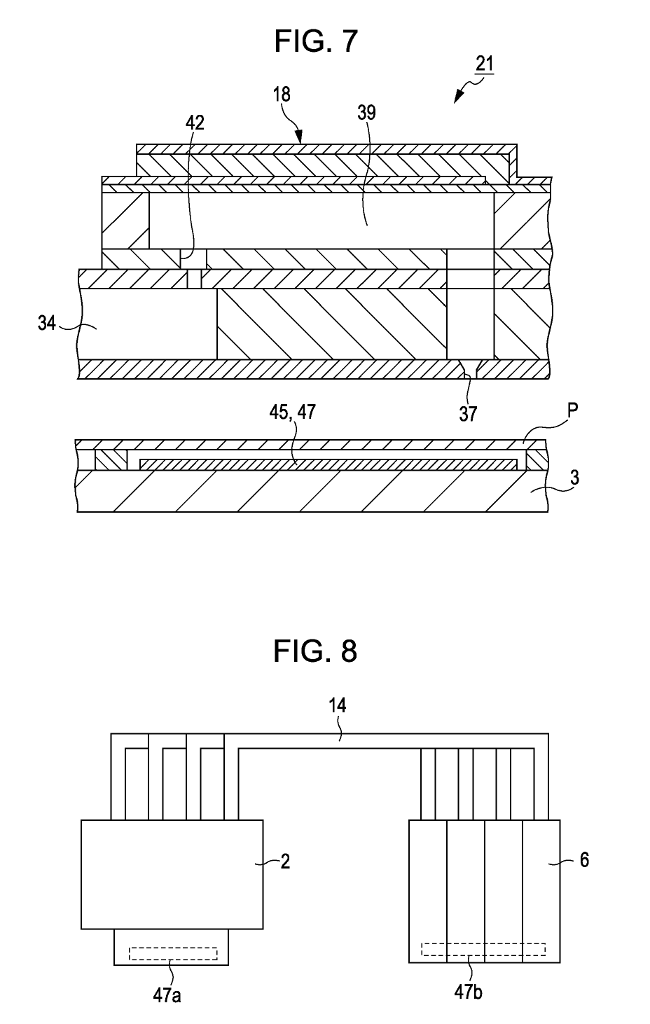

With respect to the heating mechanism 47, the aforementioned embodiment discusses an exemplary configuration in which the ink within the reservoir 34 is heated; however, it should be noted that the configuration is not limited thereto. For example, as shown in FIG. 2, a configuration may be employed in which the heating mechanism 47 is installed outside of the ink flow channel in the recording head 2, or more specifically, on a side surface of a head cover 10, and the ink within the recording head 2 is then heated by the heating mechanism 47. Alternatively, as shown in FIG. 7, it is possible to employ a configuration in which the heating mechanism 47 is installed in a different location than the recording head 2, such as on the platen 3 that supports the recording paper, which makes it possible to indirectly heat the ink within the recording head 2.

It is also possible to employ a configuration in which, as shown in FIG. 8, the heating mechanism 47 is configured of a head-side heating unit 47a for heating the ink within the ink flow channel of the recording head 2 and a supply-side heating unit 47b for heating the ink held within the ink cartridge 6, and the respective heating units 47a and 47b are controlled individually. The supply-side heating unit 47b is configured so as to reduce the viscosity of the ink within the ink cartridge 6 by heating that ink so that the ink can be pressure-transferred to the recording head 2 as efficiently and smoothly as possible with a small amount of force. When the foam elimination flushing process is carried out, the printer controller 51 puts the supply-side heating unit 47b in a heating state and also puts the head-side heating unit 47a in a non-heating state. Accordingly, the temperature of the ink drops by the time the ink reaches the pressure chamber 39, the nozzles 37, and so on of the recording head 2 even while the ease of supply of the ink from the ink cartridge 6 to the recording head 2 is ensured; thus the foam is in a more soluble state with respect to the ink during the foam elimination flushing process than when the ink is heated by at least the head-side heating unit 47a, which makes it possible to sufficiently discharge the foam within the ink. Note that the head-side heating unit 47a and the supply-side heating unit 47b may be configured so as to directly heat the ink, or may be configured so as to indirectly heat the ink.

Furthermore, although the aforementioned embodiment describes an exemplary configuration in which the heating mechanism 47 is turned off (in a non-heating state) when the foam elimination flushing process is carried out, the configuration is not limited thereto. That is, it is acceptable for the heating mechanism 47 to be controlled so that the temperature of the ink when the foam elimination flushing process is carried out may be lower than the temperature of the ink when the printing process is carried out, and thus a configuration may be employed in which the heating mechanism 47 is turned on (in a heating state) when the foam elimination flushing process is carried out. The same effects as in the aforementioned embodiment can be achieved through such a configuration as well.

Furthermore, although a so-called flexurally-vibrating piezoelectric element 18 is described as an example of the pressure generation unit in the aforementioned embodiment, the pressurizing unit is not limited thereto, and, for example, a so-called longitudinally-vibrating piezoelectric element can be employed as well. In such a case, the direction of the change in the potential of the driving signal illustrated as an example, or in other words, the vertical direction of the waveform, is inverted.

Furthermore, although an ink jet printer 1, which is a type of liquid ejecting apparatus, is described as an example in the foregoing, the invention can be applied to other liquid ejecting apparatuses in which residual foam is an issue. For example, the invention can also be applied in display manufacturing apparatuses for manufacturing color filters for liquid-crystal displays and so on, electrode manufacturing apparatuses for forming electrodes for organic EL (electroluminescence) displays, FEDs (field emission displays), and so on, chip manufacturing apparatuses for manufacturing biochips (biochemical devices), micropipettes for supplying precise small amounts of sample solutions, and so on. In such display manufacturing apparatuses, solutions having R (red), G (green), and B (blue) coloring materials are ejected from coloring material ejecting heads. Meanwhile, in electrode manufacturing apparatuses, electrode materials are ejected in liquid form from electrode material ejection heads. In chip manufacturing apparatuses, bioorganic matter solutions are ejected from bioorganic matter ejection heads.

What is claimed is:

1. A liquid ejecting apparatus comprising:
a liquid ejecting head, including a liquid flow channel having a nozzle from which a liquid is ejected and a pressure chamber that communicates with the nozzle, that ejects the liquid from the nozzle by driving a pressure generation unit and instigating a fluctuation in the pressure of the liquid within the pressure chamber;
a heating unit that directly or indirectly heats the liquid; and
a control unit that controls ejection operations of the liquid ejecting head and controls the heating unit,
wherein the control unit is configured to be capable of generating a maintenance driving signal that includes a pulse that removes foam from within the liquid flow channel by driving the pressure generation unit; and
the control unit carries out a maintenance process for restoring the ejection capability of the liquid ejecting head using the maintenance driving signal before the liquid within the liquid flow channel is heated by the heating unit.

2. A liquid ejecting apparatus comprising:
a liquid ejecting head, including a liquid flow channel having a nozzle from which a liquid is ejected and a pressure chamber that communicates with the nozzle, that ejects the liquid from the nozzle by driving a pressure generation unit and instigating a fluctuation in the pressure of the liquid within the pressure chamber;
a heating unit that directly or indirectly heats the liquid; and
a control unit that controls ejection operations of the liquid ejecting head and controls the heating unit,
wherein the control unit is configured to be capable of generating a maintenance driving signal that includes a pulse that removes foam from within the liquid flow channel by driving the pressure generation unit; and
the control unit controls the heating unit so that the temperature of the liquid within the liquid flow channel when a maintenance process for restoring the ejection capability of the liquid ejecting head using the maintenance driving signal is carried out is lower than the temperature of the liquid within the liquid flow channel when the liquid is ejected onto a landing target.

3. The liquid ejecting apparatus according to claim 1, further comprising:
a liquid holding member that holds the liquid; and
a supply unit that supplies the liquid within the liquid holding member to the liquid ejecting head,
wherein the heating unit includes a supply-side heating unit that directly or indirectly heats the liquid supplied from the liquid holding member to the liquid ejecting head and a head-side heating unit that directly or indirectly heats the liquid within the liquid flow channel of the liquid ejecting head; and
the control unit puts the supply-side heating unit in a heating state and also puts the head-side heating unit in a non-heating state when performing the maintenance process.

4. The liquid ejecting apparatus according to claim 1,
Wherein, by driving the pressure generation unit, the pulse includes:
a first change section in which a potential changes in a first direction and causes the volume of the pressure chamber to change;
a holding section in which the ending potential of the first change section is held for a set amount of time and the volume of the pressure chamber changed by the first change section is held; and
a second change section in which the potential changes from the ending potential of the first change section in a second direction, which is the opposite direction than the first direction, and causes the volume of the pressure chamber to change,
wherein the pulse is set so that the pressure change within the pressure chamber is greater than the pressure change resulting from an ejection driving pulse for ejecting the liquid onto a landing target.

5. A control method for a liquid ejecting apparatus, the liquid ejecting apparatus including a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber, a heating unit that directly or indirectly heats the liquid, and a control unit that controls ejection operations of the liquid ejecting head and controls the heating unit, the method comprising:
generating a maintenance driving signal that includes a pulse that removes foam from within the liquid flow channel by driving the pressure generation unit; and
carrying out a maintenance process for restoring the ejection capability of the liquid ejecting head using the maintenance driving signal before a process for heating the liquid within the liquid flow channel is executed by the heating unit.

6. A control method for a liquid ejecting apparatus, the liquid ejecting apparatus including a liquid ejecting head, having a liquid flow channel that has a nozzle from which a liquid is ejected and a pressure chamber that communicates with the nozzle, that ejects the liquid from the nozzle by driving a pressure generation unit and instigating a fluctuation in the pressure of the liquid within the pressure chamber, a heating unit that directly or indirectly heats the liquid, and a control unit that controls ejection operations of the liquid ejecting head and controls the heating unit, the method comprising:
generating a maintenance driving signal that includes a pulse that removes foam from within the liquid flow channel by driving the pressure generation unit; and
controlling the heating unit so that the temperature of the liquid within the liquid flow channel when a maintenance process for restoring the ejection capability of the liquid ejecting head using the maintenance driving signal is carried out is lower than the temperature of the liquid within the liquid flow channel when the liquid is ejected onto a landing target.
